(19) United States
(12) Patent Application Publication
(10) Pub. No.: US 2008/0021611 A1
(43) Pub. Date: Jan. 24, 2008

(54) Method and apparatus for controlling ride height and leveling of a vehicle having air suspension

(76) Inventors: Grant W. Hiebert, Salmon Arm (CA); Jack W. Fenkhuber, Salmon Arm (CA); Nathan Illerbrun, Salmon Arm (CA)

Correspondence Address: ANTONY C. EDWARDS, SUITE 200 - 270 HIGHWAY 33 WEST, KELOWNA, BC, V1X 1X7, US

(21) Appl. No.: 11/878,202

(22) Filed: Jul. 23, 2007

Related U.S. Application Data
(60) Provisional application No. 60/832,125, filed on Jul. 21, 2006.

(51) Int. Cl. B60G 17/018; B60G 11/27

(52) U.S. Cl. 701/37

(57) ABSTRACT

A suspension system which upon detecting a fault such as a failed sensor, takes an inventory of the remaining operational components in the system and attempts to use the remaining operational components to keep the ride height and leveling system working. The system may open a cross-flow valve operating in fluid communication between the airbag in the corner containing a failed component such as a failed valve and the airbag in the corresponding opposite corner in that end of the vehicle to average the height data in that end of the vehicle and use the remaining operational valve in that end of the vehicle, while leaving independent or enabling the independence of the airbags in the corners of the opposite end of the vehicle so as to maintain a virtual three airbag suspension system.

### CROSS REFERENCE TO RELATED APPLICATION

This application claims priority from U.S. Provisional Patent Application No. 60/832,125 filed Jul. 21, 2006 entitled Method and Apparatus for Controlling Ride Height and Leveling of a Vehicle Having Air Suspension.

### FIELD OF THE INVENTION

This invention relates to the field of control systems for controlling the attitude of vehicles while static or dynamically in motion and in particular to an improved method and apparatus for controlling ride height while in motion and static leveling of a vehicle having front and rear air suspension.

### BACKGROUND OF THE INVENTION

In the prior art it is known to individually level a vehicle with respect to gravity while it is parked and it is known to individually level a vehicle with respect to the road surface while it is traveling. In applicant's experience it is not known in the prior art to use features of the parked and traveling methods to synergistically increase the abilities of the other nor to combine actuators on one end of a vehicle to provide a single virtual actuator which may be deselected to revert to independent actuation in each corner of that end upon various faults or otherwise the independence of the actuators in the corners of the opposite end of the vehicle being lost.

In particular, as one example of the prior art, applicant is aware of Hiebert U.S. Pat. No. 7,066,474 which issued Jun. 27, 2006, entitled Electronic Suspension and Level Control System for Recreational Vehicles.

### SUMMARY OF THE INVENTION

Vehicle height sensors may be placed near each end of both the steering and drive axles. Each of these sensors is adapted to determine the distance between the chassis of the vehicle and the axle at the position of the sensor. Since the wheels and tires of the vehicle do not change appreciably in height, the height sensors may therefore also be used to determine the distance between the chassis of the vehicle and the ground at the position of the sensor.

Also mounted on the vehicle are valves used to inflate or deflate the air bags at each corner of the vehicle as well as valves that may be used to selectively parallel the air bags on each side of a given end of the vehicle, that is, one cross-over valve may selectively allow the free passage of air between airbags on opposite sides of a first end of the vehicle and another such cross-over valve may selectively allow the free passage of air between airbags on opposite sides of an opposite second end of the vehicle.

In some cases there would also be provided sensors, each employing at least one axis of accelerometer sensing that are at times used for tilt sensing during static leveling and at other times used to provide dynamic acceleration data to the control system while the vehicle is driving, that is, in motion. One or more sensing axes run parallel to the road surface with at least one sensing laterally across the vehicle (herein axis X) and at least one sensing longitudinally along the vehicle (herein axis Y). Additionally, an axis measuring acceleration perpendicular to the road surface can be used for additional data (herein axis Z).

This combination of components, and how the data from the sensors is used to control the valves, forms one aspect of the present invention.

In summary then, the present invention may be characterized in one aspect as including an apparatus and corresponding method for ride height control and/or static leveling of a vehicle having air suspension in all four corners of the vehicle, the apparatus including airbags, ride height sensors, an air supply, air supply valves, an averaging means and a processor.

The air suspension includes at least one selectively inflatable and selectively deflatable airbag in each corner of four corners of the air suspended vehicle. The four corners of the vehicle are the front left and front right corners comprising the front corners of the vehicle, and the rear left and rear right corners comprising the rear corners of the vehicle. The ride height sensors include a corresponding ride height sensor mounted in each corner of the four corners for detecting a corresponding height above ground of the each corner. In one embodiment this is done by measuring the distance between the vehicle chassis and its under-carriage or axles. The air supply is a vehicle-mounted air supply and corresponding network of air-supply lines supplying compressed air from the air supply to the airbags. The air supply valves include selectively actuable valves cooperating with the air-supply lines for selective expansion or contraction of the airbags to correspondingly raise or lower the four corners of the vehicle. The averaging means and processor cooperate with at least the height sensors corresponding to at least the front corners or the rear corners for averaging height data from the front corners or the rear corners so as to emulate or otherwise provide a single pseudo height sensor in the corresponding front corners or rear corners by cross-flow by the averaging means of airflow between the corresponding corners and by averaging by the processor of the height data from either the front corners or the rear corners, but not the cross-flow between both the front corners and the cross-flow between both the rear corners simultaneously, as better described below.

In one embodiment the averaging means includes a selectively actuable cross-over valve cooperating with the processor and mounted so as to selectively share pressurized air between the airbags in the front corners or the rear corners.

In a preferred embodiment the processor computes averaging data as between the airbags and the ride height sensors in the front corners and/or as between the airbags and the ride height sensors in the rear corners. In the preferred embodiment the averaging means is provided on both the front corners and on the rear corners, with one of the averaging means normally disabled so that the sensors at that end remain acting independently. This provides a three sensor system at all times, that is, the pseudo sensor in one end and both independent sensors in the opposite end.

Thus the averaging means cooperates with the valves corresponding to the front corners and the rear corners, and the processor cooperates with the ride height sensors and the averaging means so as to detect a failure of for example one of the airbags or one of the valves or one of the ride height sensors. The processor disables the averaging means in the end of the vehicle corresponding to the end of the vehicle containing the failure. In one example, given a vehicle with one failed height sensor, the sensors in the opposite end of the vehicle are switched to or made to remain independent. The remaining operating sensor in the end of the vehicle containing the failure is switched to or made to remain independent, thereby resulting in an on-going operational three ride height sensor system.

This and other scenarios are set out in Table 1 below and may in at least one aspect be summarized as follows, wherein the vehicle may be described as having opposite first and second ends: if, as detected by the processor, a failure is detected in the first end of the vehicle and the failure is a failure status corresponding to one of the group comprising:
a) no failure detected,
b) failure of a right side ride height sensor of the ride height sensors,
c) failure of a left side ride height sensor of the ride height sensors,
d) failure of a cross-flow valve of the at least one selectively actuable cross-over valve,
e) failure of a left side control valve of the air supply valves,
f) failure of a right side control valve of the air supply valves;

and if the second end of the vehicle has the pseudo height sensor enabled, then the processor is adapted to switch the first end of the vehicle to a responsive status chosen correspondingly from the group comprising:
a) independent control of both corners of the first end,
b) only use the left side ride height sensor and enable the cross-over valve for cross flow between the both corners of the first end,
c) only use the right side ride height sensor and enable the cross-over valve for cross flow between the both corners of the first end,
d) the independent control of the both corners of the first end,
e) only use the right side control valve and enable the cross-over valve for the cross flow between the both corners of the first end,
f) only use the left side control valve and enable the cross-over valve for the cross flow between the both corners of the first end;

else if the second end of the vehicle has the pseudo height sensor disabled so as to enable independent control of both corners of the second end, then the processor is adapted to switch the first end of the vehicle to a responsive status chosen correspondingly from the group comprising:
a) pseudo height sensor enabled,
b) only use the left side ride height sensor and enable the cross-over valve for cross flow between the both corners of the first end,
c) only use the right side ride height sensor and enable the cross-over valve for cross flow between the both corners of the first end,
d) average the height data from the ride height sensors in the both corners of the first end and selectively independently actuate the air supply valves in the both corners of the first end,
e) only use the right side control valve and enable the cross-over valve for the cross flow between the both corners of the first end,
f) only use the left side control valve and enable the cross-over valve for the cross flow between the both corners of the first end.

In essence, the system upon detecting a fault such as a failed sensor, takes an inventory of the remaining operational components and attempts to use the remaining operational components to keep the ride height and leveling system working. Various scenarios are set out below but, for example, upon detection of a failed valve, the system may open a cross-flow valve operating in fluid communication between the airbag in the corner containing the failed valve and the airbag in the corresponding opposite corner in that end of the vehicle to average the height data in that end of the vehicle and use the remaining operational valve in that end of the vehicle.

TABLE 1

| | Mode of the Opposite | |
|---|---|---|
| Fault Incurred on | Second End of the | System Switches First End |
| First End of the Vehicle | Vehicle | of the Vehicle to: |
| None | Parallel (Averaged) | Independent Control |
| Right Ride Height Sensor | Parallel (Averaged) | Left Sensor only w/ Crossflow Enabled |
| Left Ride Height Sensor | Parallel (Averaged) | Right Sensor Only w/ Crossflow Enabled |
| Crossflow Valve Error | Parallel (Averaged) | Independent Control |
| Left Control Valve Error | Parallel (Averaged) | Crossflow Enabled w/ Right Control Valve |
| Right Control Valve Error | Parallel (Averaged) | Crossflow Enabled w/ Left Control Valve |
| None | Independent | Parallel (Averaged) Control |
| Right Ride Height Sensor | Independent | Left Sensor only w/ Crossflow Enabled |
| Left Ride Height Sensor | Independent | Right Sensor Only w/ Crossflow Enabled |
| Crossflow Valve Error | Independent | Average Sensors with Dual Valve Control |
| Left Control Valve Error | Independent | Crossflow Enabled w/ Right Control Valve |
| Right Control Valve Error | Independent | Crossflow Enabled w/ Left Control Valve |
| All Other or Multiple Faults | X | Lockdown |

At least one accelerometer may be mounted to the vehicle. The processor also cooperates with the accelerometer along with the ride height sensors, and the valves for processing data from both the accelerometers and the ride height sensors so as to provide enhanced data used for evaluating dynamic motions of the vehicle while in transit and corresponding ride height control by selective actuation of the valves. The improved acceleration data may also be used by the processor for static leveling of the vehicle while not in transit by the corresponding selective actuation of the valves.

The processor may cooperate with the sensors to filter unfiltered ride height data to produce ride height trend data. The trend data may be used to evaluate whether to actuate the valves.

Consistent with, and for use in conjunction with the above described system, the method according to another aspect of the present invention may be characterized as including the steps of:

providing a single pseudo height sensor in the corresponding front corners or rear corners by cross-flow by the averaging means of airflow between the corresponding corners and by averaging by the processor of the height data from either the front corners or the rear corners, but not the cross-flow between both the front corners and the cross-flow between the rear corners simultaneously, detecting by the processor of a failure adversely affecting suspension by one of the airbags, disabling by the processor of the corresponding averaging means for the corresponding front or rear corners thereby disabling the corresponding pseudo height sensor.

A further step may include providing, so as to include in the averaging means, at least one selectively actuable cross-over valve and corresponding air supply lines mounted so as to selectively share pressurized air between the airbags in the front corners or the rear corners.

The method may further include computing, by the processor, of averaging data between the airbags and corresponding ride height sensors in the front corners and/or between the airbags and corresponding ride height sensors in the rear corners.

The method may further include providing, so as to include in the averaging means, first and second averaging means respectively cooperating with the front corners and the rear corners, and biasing the processor so as to normally disable one of the first and second averaging means so that the sensors at a corresponding end of the vehicle, corresponding to the disabled averaging means, remain acting independently in that end so as to provide two independent sensors and the pseudo height sensor and thereby providing a virtual three sensor system, including the pseudo height sensor and both the independent sensors.

The method may include, where the averaging means cooperates with the valves corresponding to the front corners and the rear corners, and the processor cooperates with the ride height sensors and the averaging means, detecting, by the processor, a failure of one of the airbags or one of the valves or one of the ride height sensors, and disabling by the processor the first or second averaging means corresponding to an end of the vehicle containing the failure.

The method may further include providing at least one accelerometer mounted to the vehicle, and wherein the processor also cooperates with at least one accelerometer along with the ride height sensors, and the valves, and may also include processing by the processor of data from at least one accelerometer and the height data from the ride height sensors to provide enhanced data, and evaluating by the processor of the enhanced data to evaluate dynamic motions of the vehicle while in transit and to provide corresponding ride height control by selective actuation of the valves.

The method may further include processing by the processor of acceleration data from at least one accelerometer for use in static leveling of the vehicle while not in transit and correspondingly selectively actuating the valves.

The method may further include filtering by the processor in cooperation with the sensors, unfiltered ride height data from the height data to produce ride height trend data, and evaluating the trend data to evaluate whether to actuate the valves. Further, the method may include establishing, for a desired vehicle height, a desired position band range of heights corresponding to outer limits of a desired position of each independently controlled corner and an end of the vehicle corresponding to any enabled pseudo height sensor, and within the desired position band range of heights establishing an in-position band range of heights to allow for over-shoot or under-shoot in height adjustment by reason of sensor and processor lag-time, monitoring height position and ceasing actuation upon entry into the in-position band range of heights so as to accommodate over-shoot or under-shoot and remain within the desired position band range of heights upon settling out of the over-shoot or under-shoot.

Where the vehicle is characterized as having opposite first and second ends, the method may further include the steps of detecting, by the processor, any failure in the first end of the vehicle having a failure status corresponding to one of the group comprising:
a) no failure detected,
b) failure of a right side ride height sensor of the ride height sensors,
c) failure of a left side ride height sensor of the ride height sensors,
d) failure of a cross-flow valve of the at least one selectively actuable cross-over valve,
e) failure of a left side control valve of the air supply valves,
f) failure of a right side control valve of the air supply valves;

and if the second end of the vehicle has the pseudo height sensor enabled, then the processor switching the first end of the vehicle to a responsive status chosen correspondingly from the group comprising:
a) independent control of both corners of the first end,
b) only use the left side ride height sensor and enable the cross-over valve for cross flow between the both corners of the first end,
c) only use the right side ride height sensor and enable the cross-over valve for cross flow between the both corners of the first end,
d) the independent control of the both corners of the first end,
e) only use the right side control valve and enable the cross-over valve for the cross flow between the both corners of the first end,
f) only use the left side control valve and enable the cross-over valve for the cross flow between the both corners of the first end;

else if the second end of the vehicle has the pseudo height sensor disabled so as to enable independent control of both corners of the second end, then the processor switching the first end of the vehicle to a responsive status chosen correspondingly from the group comprising:
a) pseudo height sensor enabled,
b) only use the left side ride height sensor and enable the cross-over valve for cross flow between the both corners of the first end,
c) only use the right side ride height sensor and enable the cross-over valve for cross flow between the both corners of the first end,
d) average the height data from the ride height sensors in the both corners of the first end and selectively independently actuate the air supply valves in the both corners of the first end,
e) only use the right side control valve and enable the cross-over valve for the cross flow between the both corners of the first end,
f) only use the left side control valve and enable the cross-over valve for the cross flow between the both corners of the first end.

### BRIEF DESCRIPTION OF THE DRAWINGS

FIG. 1 is a graph showing one example of the relationship between unfiltered vehicle height data and the corresponding height trend line for use in adjusting vehicle ride height so as to lie between a desired ride height position band and to correct for overshoot and undershoot.

FIG. 2 is a diagrammatic view of one example of a vehicle suspension air schematic incorporating one aspect of the present invention.

FIG. 3a is one example of a software status screen indicating normal condition functioning of the system according to the present invention.

FIG. 3b is the status display of FIG. 3a illustrating status changes due to a failed left rear ride height sensor.

FIG. 4 is a side elevation view of a recreational vehicle being leveled and adjusted for desired height of the door above ground.

FIG. 5 is, in partially cut away perspective view, one example of a ride height sensor mounted between a vehicle chassis and axle supporting frame in the wheel well of a vehicle having air suspension in four corners.

### DETAILED DESCRIPTION OF EMBODIMENTS OF THE INVENTION

### Ride Height Control System

### Filtered Vs Raw Height Sensor Data Usage

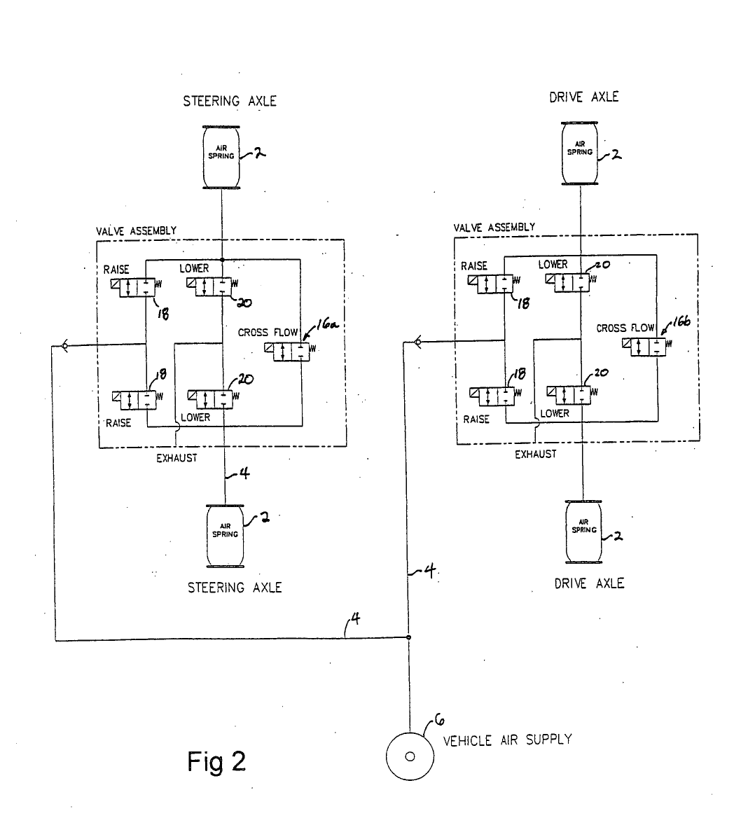

With reference to FIG. 2, vehicles using air suspension commonly use air bags 2 that have significant volume relative to the sizes of the air feed lines 4 and corresponding air flow rates feeding them. The response time when inflating or deflating the airbags is therefore relatively slow. For this reason it is not feasible in most systems to consider continual corrections to ride height every time a sensor indicates that a given corner of the vehicle is outside its desired position range. Attempting to make that kind of correction only serves to consume compressed air at rates far in excess of what the vehicle air compressors 6 are able to generate.

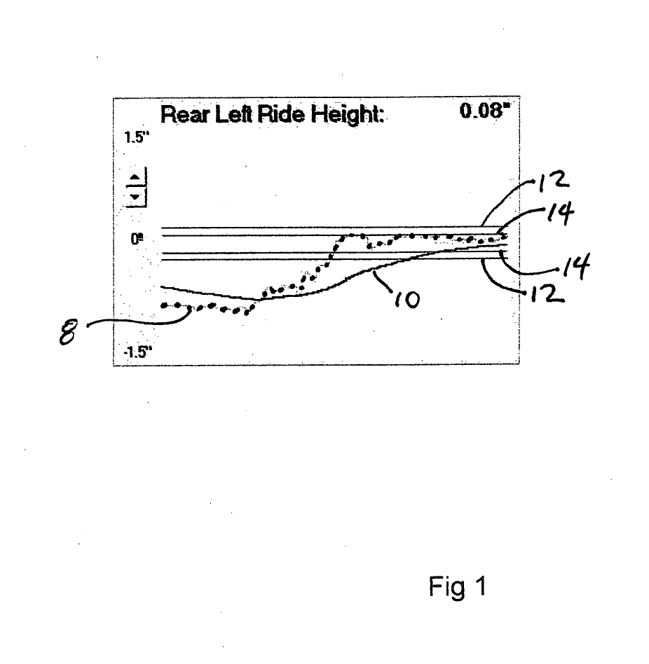

Therefore, in the previous instance, the data from the ride height sensors is filtered in order to get an understanding of what the height trend is rather than what the current actual position is. This allows the accurate determination of the current nominal height of the vehicle with respect to the road surface. FIG. 1 indicates the actual height position (line 8), illustrated diagrammatically as a dotted line for clarity, and the filtered height trend line 10. While the height trend line 10 may be used to indicate whether the vehicle height is in the desired position band (lines 12) or not, the actual height position is used to determine when to stop making the correction. This ensures that corrections are based on trended height data and not sporadic height measurements. Using the raw height data to determine when to stop the correction ensures very accurate control of the final height without generating too much over or under shoot.

### Desired Position Band Vs. in Position Band

When leveling a vehicle statically, it is desired that the time to achieve level be as short as possible. To this end, valves with high flow rates are typically used in order to raise or lower the vehicle as quickly as possible. During times of dynamic height control, these high flow valves coupled with slight delays in sensor feedback can often cause the system to over shoot its targeted position when making a height correction. Thus, one aspect of the present invention incorporates an in position band that falls within the desired position band. FIG. 1 illustrates how the two bands, i.e. the desired position bands and in the position bands, work in conjunction with each other. If the trended height of the vehicle (line 10) falls outside of the desired position band (lines 12), that is, the outermost bands for a period of time, a correction is made by energizing a valve to either raise or lower the vehicle as required. In order to have the vehicle end up as close as possible to a position in the center of the desired position band in position bands (lines 14) are used to tell the valve when to stop correcting. In the illustrated example of FIG. 1, the correction was discontinued as soon as the actual height value crossed the lower line 14 but over shoot caused the vehicle to continue to rise slightly. The final resting height of the vehicle is very near the middle of the desired position band.

### Automatic Desired Position Band Adjustment

Various sensing devices such as the ride height sensors and accelerometers can be used to discern the ride quality that is currently being felt in the vehicle. This ride quality can be used to estimate the roughness of the road surface that is being traveled on. If the vehicle is traveling at low speed on a rough roadway, the desired position band may be required to be wider than if the vehicle were traveling at higher speeds on a smooth roadway. The desired position band and the in position band may be dynamically adjusted based on various inputs such as ride quality and vehicle speed.

### Ride Height Differentiation (Pitch/Roll)

The values of the ride height sensors on each corner of the vehicle may be compared in real time and the current roll or pitch angle of the vehicle calculated. For example, knowing the height difference between the two front sensors and the distance between them the roll angle of the front of the vehicle may be determined. The two rear sensors determine the rear roll angle and the sensors on a given side (front and rear) provide the pitch angle on that side of the vehicle. Comparing the respective rates of change determines the roll and pitch rates.

### Intelligent Height Correction Based on Acceleration

There are many factors that determine why a vehicle's height would go beyond the desired position band 12 or 14. The most common reasons are lateral or longitudinal accelerations which cause weight transfer in the vehicle, forcing the air bags in the higher loaded corners of the vehicle to collapse slightly thereby lowering the corresponding corners. At the same time this also allows the airbags in the lighter loaded corners to extend thereby raising those corners. Since this type of deviation from the desired position band is most likely temporary in nature, there is no real reason to correct the height because once the acceleration drops back to near zero levels, the suspension will tend to correct itself. For this reason the height correction process is modified during periods of high lateral or longitudinal acceleration or deceleration. Specifically, thresholds are put in place for lateral and longitudinal accelerations and if the vehicles accelerations are below these thresholds then the corrections are made after a specified period of time. If, however, the vehicles accelerations exceed these thresholds, the system will wait for a longer period of time before making a correction. This prevents the system from making unnecessary corrections based on data that was temporary in nature.

The industry uses mechanical valves to inflate the airbags. There is at least one airbag with the valves corresponding to three of the four airbags in each corner of the vehicle. Conventionally, a simple construction of three valves is used, the use of four valves, i.e. one valve for each of the four airbags, is generally avoided. For example, some in the industry use three-corner control, where there are two valves in the rear and one valve in the front left corner. More conventionally in the prior art, two ride height control valves are located on the rear corners of the vehicle and one ride height control valve is located on the front of the vehicle, typically mounted to the vehicle's anti-sway bar, for example half way along the anti-sway bar. In the prior art using only three valves, losing a valve would mean a breakdown.

### Height Sensing and Control Schemes

To recap, in a prior art air suspended vehicle, the height of the vehicle at each end of one of the axles is controlled independently while the combined height of the other end of the vehicle is controlled by a single valve, for a total of three valves. This effectively creates a three point height control model even though the vehicle has four distinct points of suspension. The reason for not using four points of control is that unevenness in the road surface can lead to a state where one of the four corners is unable to maintain a constant height without adversely affecting one of the remaining three. This can lead to severe imbalances in the amount of vehicle weight being carried by a given corner of the vehicle.

Where, as in the previous instance, four discrete height sensors are used, one at each corner of the vehicle, averaging the height data from the sensors on any given end in effect creates a pseudo or virtual single point sensor on that end. Alternatively, in the event of a sensor failure on that end, the failed sensor may be disregarded and the remaining functional sensor used to measure the vehicle height. In any case, the resultant data is then used to determine whether or not to lower or raise both sides of that end of the vehicle. Further more, when either averaged or single sensor methods are adopted, crossover valves 16a or 16b are used which selectively allow air to pass freely from the air bag(s) on one side of the corresponding axle to the air bag(s) on the other side. These methods of height sensing and control can be employed on either end of the vehicle at any time.

### Fault Detection and Control Shifting

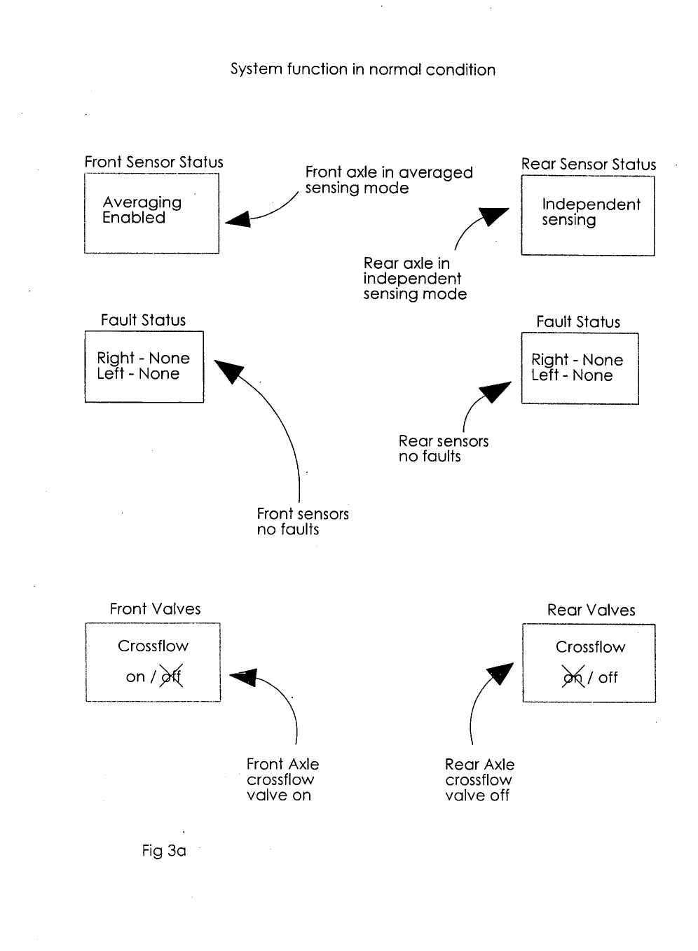

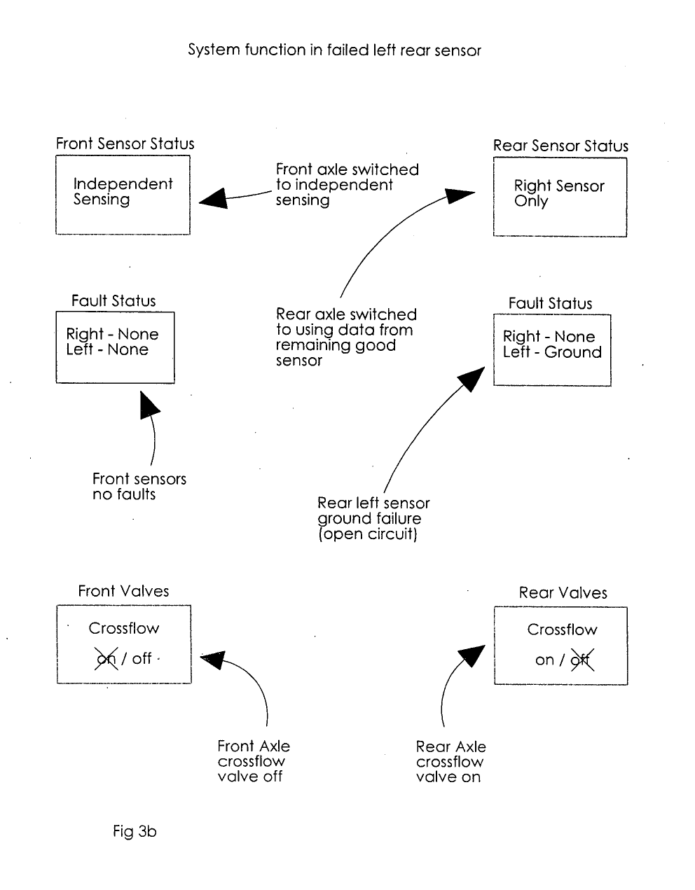

As discussed earlier, the height sensors on each of the four corners of the vehicle can employ independent sensing, averaged sensing, or single end sensing methods on either end of the vehicle at any time. Integrated sensor failure diagnostics that indicate the status of each sensor enable the control system to determine which control method to use at a given time. For example in a system that is operating normally, the front of the vehicle (labeled as steering axle in FIG. 2) could be running in averaged mode with its cross over valve 16a open while the rear of the vehicle (labeled as drive axle in FIG. 2) would be running in independent mode with cross over valve 16b closed. If a sensor failure is detected in one of the rear sensors, the rear could switch to the single sensor sensing method using data from the remaining good sensor and open the crossover valve 16b on the rear axle. At the same time, the front would switch to independent control and close its cross over valve 16a. The failure of both sensors on one or both ends of the vehicle would simply cause the raising or lowering functions of that end to cease. Although visual and audible fault warnings to the driver would indicate that a problem exists, the vehicle would still be drivable in emergency cases. The images in FIGS. 3a and 3b reflect respectively the system in its normal status and the system having reacted and adjusted for a failed left rear sensor. Table 1 represents various states of sensor failure and the corresponding control states.

### Leaking Valve Detection

The height sensors are able to determine if there is a consistent trend that a given corner is repeatedly raising or lowering without control commands to do so. While the current method of control is able to compensate for that by making the appropriate corrections, the control system also able to predict that these non-requested height changes are the result of a leaking raise valve 18 or lower valve 20. This conclusion can then be reported to the vehicle operator and the correct service actions can be taken.

### Static Vehicle Leveling

### Grade Algorithm

The leveling system uses a pulse train output signal from the vehicle's transmission to determine vehicle speed. This pulse train is now available on almost any production transmissions and is typically calibrated in pulses per mile of vehicle travel. If measured, the duration of each pulse in the train allows determination of the time it took to cover a known distance and therefore also the vehicle speed. From the rate of change in speed over time, the vehicle's longitudinal acceleration rate may also be determined. The Y axis accelerometer in the leveling system can also determine the vehicle's longitudinal acceleration rate. There is an offset though in the acceleration value that is taken from the accelerometer. Because the accelerometer is sensing the acceleration imparted on it in any form, it not only senses the vehicle acceleration rate but also senses the amount of longitudinal tilt in the vehicle. Although it is difficult to discern the amount of tilt that is in the combined acceleration output of the accelerometer solely by analyzing that data, if you compare the accelerometer value to the transmission signal acceleration value, the difference between the two is the tilt of the vehicle. In a dynamic state, this value is directly related to the slope or grade of the road surface being traveled upon. Hence the slope or grade of the road surface can be determined.

### Combined Leveling and Electronic Ride Height System

### Faster Detection of End of Stroke Sensing in Air Bags or Hydraulic Cylinders

During static leveling of a parked vehicle, it is currently necessary to monitor the movement of the vehicle during leveling in order to determine whether the air bags have reached the end of their travel. This is typically done by monitoring the tilt sensor(s) and noting the change in tilt angle over time. Since the tilt angle changes relatively slowly, the amount of time required to confirm that the coach is no longer raising or lowering can be excessive. Using the ride height sensors to indicate that a maximum or minimum threshold of height has been achieved at a given sensing point allows the leveling process to be executed much quicker. For example, if a vehicle needs to be lowered in the front to get level, the front will be lowered until one or more front height sensors indicate that the air bag(s) have bottomed out. Immediately after sensing this, since it has been determined that the front can not lower any further, the rear can now be requested to raise. This method of detecting the end of stroke during leveling can significantly decrease the total amount of time required to level the vehicle.

### Ground Contact Detection During Leveling

In current leveling systems, whether for example using hydraulic or electric jacks, there are various methods used to determine the point at which the jacks make contact with the ground. Some systems monitor the hydraulic pressure in the hydraulic cylinder and when the hydraulic pressure rises they assume the jacks are in contact with the ground. Others in the prior art monitor the electrical current that the motor driving either the hydraulic pump or electric screw is requiring as the case may be. Still others in the prior art monitor the leveling tilt sensors to detect movement in the vehicle. All of these prior art methods may inadvertently indicate ground contact either before it actually occurs or long after it occurs.

Once the leveling jacks make contact with the ground, the chassis begins to lift and the height between the chassis and the axle begins to increase since the vehicle load is now being transferred from the suspension components to the leveling jacks. In the present invention this change in height can be very accurately measured using the ride height sensors. The ride height sensors can therefore be used to positively indicate that the leveling jacks, whether they be hydraulic or electric, have made contact with the ground.

### Incremental Height Adjustment after Leveling

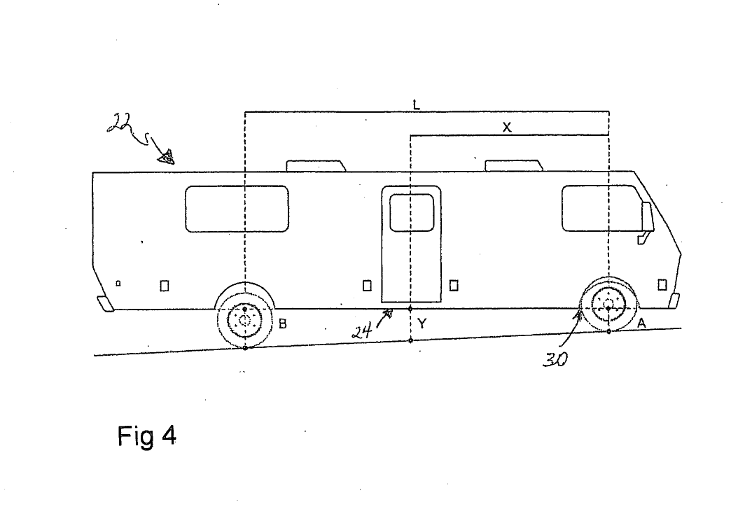

When leveling a recreational vehicle (RV) 22 as seen in FIG. 4, it is often desirable to have the entry step 24 to the vehicle be at a certain desired height. If, after leveling, the vehicle height is not to the satisfaction of the operator, the ride height sensors can be used to allow the owner to raise or lower the vehicle in known increments. For example, after leveling, if the operator were to press the raise button on the control keypad once, the vehicle could be raised by 1 inch at all corners simultaneously. If the vehicle is still not at the desired height then the process could be repeated. Conversely, if the vehicle is too high it could be lowered in the same incremental manner by pressing the lower button on the control keypad.

### Leveling at a Known Height

As stated above, when leveling an RV it is often desirable to end up with the vehicle's entry step at a specific height from the ground. Once the vehicle is leveled and the current step height is determined, the leveling controller can then raise or lower the coach until the desired step height is achieved. Knowing the vehicle height at the suspension points of a leveled vehicle, the height of the step can be calculated using the following formula.

$$Y = X [ \frac{( B - A )}{L} ] + A$$

where as illustrated in FIG. 4:

Y=desired height of the entry step

X=distance from front axle to center of entry door

L=distance between front and rear axles

A=front vehicle height

B=rear vehicle height

### Example of Ride Height Sensor

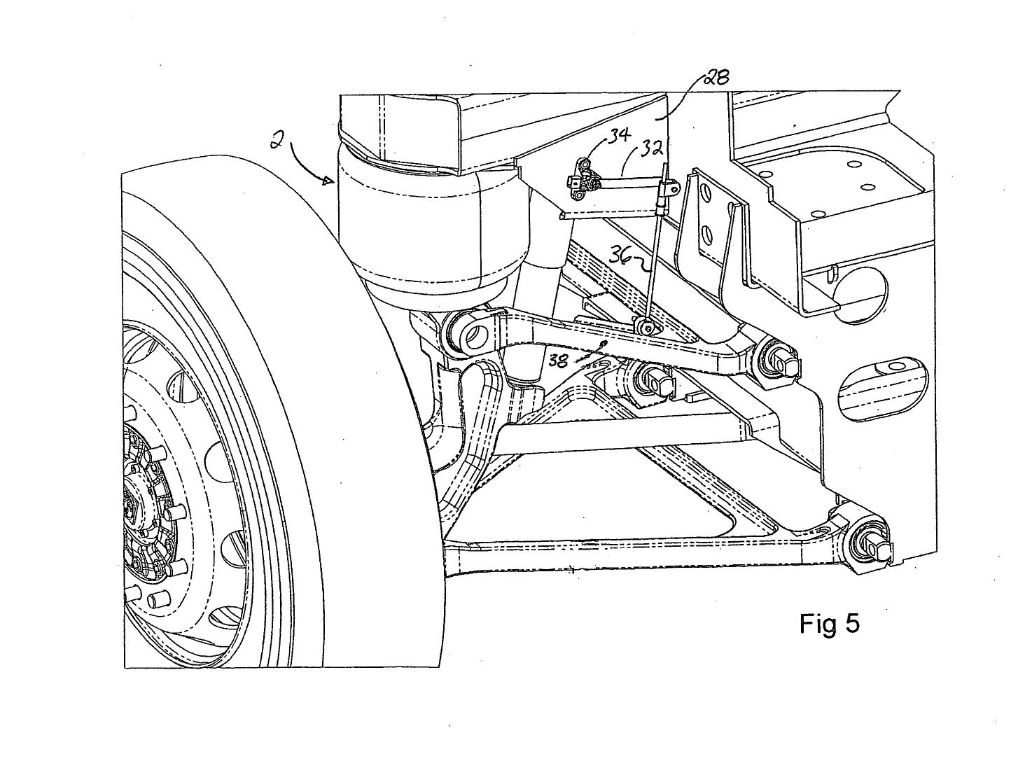

Illustrated by way of example in FIG. 5 is a ride height sensor 34 mounted to a chassis 28 of vehicle 22. A lever arm 32 is pivotally mounted at one end of the lever arm to a sensor 34, such as a sensor supplied by American Electronics Components Inc. for use in automobiles for detecting rotation of, and sensing the degree of rotation of, lever arm 32 relative to the body of sensor 34. The opposite end of lever arm 32 is pivotally mounted to the distal end of a rigid strut 36 fixedly mounted at its base end to vehicle suspension member 38. Airbag 2 is conventionally mounted between chassis 28 and suspension member 38.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An air suspension system for ride height control and/or static leveling of a vehicle having air suspension in all four corners of the vehicle, the system comprising airbags, ride height sensors, an air supply, air supply valves, an averaging means and a processor, wherein said air bags include at least one selectively inflatable and selectively deflatable airbag for mounting in each corner of the four corners of the vehicle and wherein the four corners of the vehicle are the front corners including the front left and front right corners and the rear corners including the rear left and rear right corners and wherein said ride height sensors include a ride height sensor mounted in each corner of the four corners of the vehicle for detecting a corresponding height above ground of each of the four corners and providing corresponding height data to said processor, and wherein said air supply is a vehicle-mounted compressed air supply and corresponding network of air-supply lines supplying compressed air from said air supply to said airbags, and wherein said air supply valves include selectively actuable valves cooperating with said air-supply lines for selective inflation and expansion or deflation and contraction of said airbags to correspondingly and selectively raise or lower the four corners of said vehicle, and wherein said averaging means and said processor cooperate with at least said height sensors corresponding to at least the front corners or the rear corners for averaging height data from the front corners or the rear corners so as to provide a single pseudo height sensor in the corresponding front corners or rear corners by cross-flow by said averaging means of airflow between said corresponding corners and by averaging by said processor of said height data from either said front corners or said rear corners, but not said cross-flow between both the front corners and said cross-flow between the rear corners simultaneously, and wherein, upon detection by said processor of a failure adversely affecting suspension by one of said airbags, said processor is adapted to disable the corresponding averaging means for the corresponding front or rear corners thereby disabling the corresponding said pseudo height sensor.

2. The system of claim 1 wherein said averaging means includes at least one selectively actuable cross-over valve and corresponding air supply lines mounted so as to selectively share pressurized air between said airbags in said front corners or said rear corners.

3. The system of claim 2 wherein said processor is adapted to compute averaging data between said airbags and corresponding said ride height sensors in the front corners and/or between said airbags and corresponding said ride height sensors in said rear corners.

4. The system of claim 1 wherein said averaging means are first and second averaging means respectively cooperating with said front corners and said rear corners, and wherein said processor is biased so as to normally disable one of said first and second averaging means so that said sensors at a corresponding end of the vehicle, corresponding to the disabled said averaging means, remain acting independently in that end so as to provide two independent sensors and said pseudo height sensor and thereby providing a virtual three sensor system, including said pseudo height sensor and both said independent sensors.

5. The system of claim 4 wherein said averaging means cooperates with said valves corresponding to the front corners and the rear corners, and said processor cooperates with said ride height sensors and said averaging means so as to detect a failure of one of said airbags or one of said valves or one of said ride height sensors, and wherein said processor is adapted to disable said first or second averaging means corresponding to an end of said vehicle containing said failure.

6. The system of claim 5 wherein at least one accelerometer is mounted to said vehicle, and wherein said processor also cooperates with said at least one accelerometer along with said ride height sensors, and said valves for processing data from said at least one accelerometer and said height data from said ride height sensors so as to provide enhanced data for use by said processor whereby said processor evaluates dynamic motions of the vehicle while in transit and provides corresponding ride height control by selective actuation of said valves.

7. The system of claim 6 wherein acceleration data from said at least one accelerometer is used by said processor for static leveling of the vehicle while not in transit by the corresponding selective actuation of said valves.

8. The system of claim 5 wherein said processor is adapted to cooperate with said sensors to filter unfiltered ride height data from said height data to produce ride height trend data, and wherein said processor is adapted to evaluate said trend data to evaluate whether to actuate said valves.

9. The system of claim 5 wherein said ride height sensors measure the distance between the vehicle chassis of said vehicle and the under-carriage or axles of the vehicle.

10. The system of claim 3 wherein the vehicle has opposite first and second ends, and wherein if, as detected by said processor, said failure is in said first end of the vehicle and said failure is a failure status corresponding to one of the group comprising:
a) no failure detected,
b) failure of a right side ride height sensor of said ride height sensors,
c) failure of a left side ride height sensor of said ride height sensors,
d) failure of a cross-flow valve of said at least one selectively actuable cross-over valve,
e) failure of a left side control valve of said air supply valves,
f) failure of a right side control valve of said air supply valves;
and if said second end of the vehicle has said pseudo height sensor enabled,
then said processor is adapted to switch said first end of the vehicle to a responsive status chosen correspondingly from the group comprising:
a) independent control of both corners of said first end,
b) only use said left side ride height sensor and enable said cross-over valve for cross flow between said both corners of said first end,
c) only use said right side ride height sensor and enable said cross-over valve for cross flow between said both corners of said first end,
d) said independent control of said both corners of said first end,
e) only use said right side control valve and enable said cross-over valve for said cross flow between said both corners of said first end,
f) only use said left side control valve and enable said cross-over valve for said cross flow between said both corners of said first end;
else if said second end of the vehicle has said pseudo height sensor disabled so as to enable independent control of both corners of said second end,
then said processor is adapted to switch said first end of the vehicle to a responsive status chosen correspondingly from the group comprising:
a) pseudo height sensor enabled,
b) only use said left side ride height sensor and enable said cross-over valve for cross flow between said both corners of said first end,
c) only use said right side ride height sensor and enable said cross-over valve for cross flow between said both corners of said first end,
d) average said height data from said ride height sensors in said both corners of said first end and selectively independently actuate said air supply valves in said both corners of said first end,
e) only use said right side control valve and enable said cross-over valve for said cross flow between said both corners of said first end,
f) only use said left side control valve and enable said cross-over valve for said cross flow between said both corners of said first end.

11. For use in an air suspension system for ride height control and/or static leveling of a vehicle having air suspension in all four corners of the vehicle, wherein the system includes airbags, ride height sensors, an air supply, air supply valves, an averaging means and a processor, and wherein said air bags include at least one selectively inflatable and selectively deflatable airbag mounted in each corner of the four corners of the vehicle and wherein the four corners of the vehicle are the front corners including the front left and front right corners and the rear corners including the rear left and rear right corners and wherein said ride height sensors include a ride height sensor mounted in each corner of the four corners of the vehicle for detecting a corresponding height above ground of each of the four corners and for providing corresponding height data to said processor, and wherein said air supply is a vehicle-mounted compressed air supply and corresponding network of air-supply lines supplying compressed air from said air supply to said airbags, and wherein said air supply valves include selectively actuable valves cooperating with said air-supply lines for selective inflation and expansion or deflation and contraction of said airbags to correspondingly and selectively raise or lower the four corners of said vehicle, and wherein said averaging means and said processor cooperate with at least said height sensors corresponding to at least the front corners or the rear corners for averaging height data from the front corners or the rear corners, a method for controlling the air suspension system comprising the steps of:
providing a single pseudo height sensor in the corresponding front corners or rear corners by cross-flow by said averaging means of airflow between said corresponding corners and by averaging by said processor of said height data from either said front corners or said rear corners, but not said cross-flow between both the front corners and said cross-flow between the rear corners simultaneously,
detecting by said processor of a failure adversely affecting suspension by one of said airbags,
disabling by said processor of the corresponding averaging means for the corresponding front or rear corners thereby disabling the corresponding said pseudo height sensor.

12. The method of claim 11 further comprising the step of providing, so as to include in said averaging means, at least one selectively actuable cross-over valve and corresponding air supply lines mounted so as to selectively share pressurized air between said airbags in said front corners or said rear corners.

13. The method of claim 12 further comprising the step of computing, by said processor, of averaging data between said airbags and corresponding said ride height sensors in the front corners and/or between said airbags and corresponding said ride height sensors in said rear corners.

14. The method of claim 11 further comprising the step of providing, so as to include in said averaging means, first and second averaging means respectively cooperating with said front corners and said rear corners, and biasing said processor so as to normally disable one of said first and second averaging means so that said sensors at a corresponding end of the vehicle, corresponding to the disabled said averaging means, remain acting independently in that end so as to provide two independent sensors and said pseudo height sensor and thereby providing a virtual three sensor system, including said pseudo height sensor and both said independent sensors.

15. The method of claim 14 wherein said averaging means cooperates with said valves corresponding to the front corners and the rear corners, and said processor cooperates with said ride height sensors and said averaging means, said method comprising the step of detecting, by said processor, a failure of one of said airbags or one of said valves or one of said ride height sensors, and disabling by said processor said first or second averaging means corresponding to an end of said vehicle containing said failure.

16. The method of claim 15 further comprising the step of providing at least one accelerometer mounted to said vehicle, and wherein said processor also cooperates with said at least one accelerometer along with said ride height sensors, and said valves, and processing by said processor of data from said at least one accelerometer and said height data from said ride height sensors to provide enhanced data, and evaluating by said processor of said enhanced data to evaluate dynamic motions of the vehicle while in transit and to provide corresponding ride height control by selective actuation of said valves.

17. The method of claim 16 further comprising the step of processing by said processor of acceleration data from said at least one accelerometer for use in static leveling of the vehicle while not in transit and correspondingly selectively actuating said valves.

18. The method of claim 15 further comprising the step of filtering by said processor in cooperation with said sensors, unfiltered ride height data from said height data to produce ride height trend data, and evaluating said trend data to evaluate whether to actuate said valves.

19. The method of claim 18 further comprising the steps of establishing, for a desired vehicle height, a desired position band range of heights corresponding to outer limits of a desired position of each said independently controlled corner of said four corners and an end of the vehicle corresponding to any enabled said pseudo height sensor, and within said desired position band range of heights an in-position band range of heights to allow for over-shoot or under-shoot in height adjustment by reason of sensor and processor lag-time, and including the step of monitoring height position and ceasing actuation upon entry into said in-position band range of heights so as to accommodate over-shoot or under-shoot and remain within said desired position band range of heights upon settling out of said over-shoot or under-shoot.

20. The method of claim 15 further comprising the step of measuring by said ride height sensors the distance between the vehicle chassis of said vehicle and the under-carriage or axles of the vehicle.

21. The method of claim 13, and wherein the vehicle has opposite first and second ends, further comprising the steps of detecting by said processor, of any failure in said first end of the vehicle having a failure status corresponding to one of the group comprising:
a) no failure detected,
b) failure of a right side ride height sensor of said ride height sensors,
c) failure of a left side ride height sensor of said ride height sensors,
d) failure of a cross-flow valve of said at least one selectively actuable cross-over valve,
e) failure of a left side control valve of said air supply valves,
f) failure of a right side control valve of said air supply valves;
and if said second end of the vehicle has said pseudo height sensor enabled,
then said processor switching said first end of the vehicle to a responsive status chosen correspondingly from the group comprising:
a) independent control of both corners of said first end,
b) only use said left side ride height sensor and enable said cross-over valve for cross flow between said both corners of said first end,
c) only use said right side ride height sensor and enable said cross-over valve for cross flow between said both corners of said first end,
d) said independent control of said both corners of said first end,
e) only use said right side control valve and enable said cross-over valve for said cross flow between said both corners of said first end,
f) only use said left side control valve and enable said cross-over valve for said cross flow between said both corners of said first end;
else if said second end of the vehicle has said pseudo height sensor disabled so as to enable independent control of both corners of said second end,
then said processor switching said first end of the vehicle to a responsive status chosen correspondingly from the group comprising:
a) pseudo height sensor enabled,
b) only use said left side ride height sensor and enable said cross-over valve for cross flow between said both corners of said first end,
c) only use said right side ride height sensor and enable said cross-over valve for cross flow between said both corners of said first end,
d) average said height data from said ride height sensors in said both corners of said first end and selectively independently actuate said air supply valves in said both corners of said first end,
e) only use said right side control valve and enable said cross-over valve for said cross flow between said both corners of said first end,
f) only use said left side control valve and enable said cross-over valve for said cross flow between said both corners of said first end.
